(19) United States
(12) Patent Application Publication
(10) Pub. No.: US 2017/0036425 A1
(43) Pub. Date: Feb. 9, 2017

(54) Gloves Comprising Propylene-Based Elastomer and Methods of Making Same

(71) Applicant: EXXONMOBIL CHEMICAL PATENTS INC., Baytown, TX (US)

(72) Inventors: Bin Zhao, Shanghai (CN); Achiel Josephus Maria Van Loon, Schoten (BE); Fengjuan Xu, Shanghai (CN); Willy Jozef Joanna Leysen, Meerhout (BE)

(21) Appl. No.: 15/305,570

(22) PCT Filed: Jun. 17, 2014
(86) PCT No.: PCT/CN2014/000596

§ 371 Date: Oct. 20, 2016

(51) Int. Cl. B32B 25/04; C08L 23/14; C08L 23/06; B32B 27/32; B32B 25/14; B32B 27/08; B32B 27/18; C08J 5/18; B32B 25/08

(52) U.S. Cl. CPC B32B 25/042; C08J 5/18; C08L 23/14; C08L 23/06; B32B 25/08; B32B 25/14; B32B 27/08; B32B 27/18; B32B 27/32; B32B 27/327; C08J 2323/14; C08J 2423/06; C08L 2203/16; B32B 2270/00; B32B 2307/5825; B32B 2437/02

(57) ABSTRACT

Disclosed are gloves including a propylene-based elastomer that may provide desired use comfort and fitting characteristic.

### FIELD OF THE INVENTION

This invention relates to gloves, and in particularly, to gloves comprising a propylene-based elastomer, and methods of making them.

### BACKGROUND OF THE INVENTION

Disposable gloves have been widely used for various applications, including, but not limited to, in medical procedures, food industry, biological laboratories, electromechanical and manufacturing work, inspection industry, automotive repair, household, etc., to protect hands and fingers from exposure to bacteria, viruses, and other contaminants, or to protect against contamination of, for example, pharmaceuticals and foods that are handled. Different types of materials and different processes are chosen to manufacture these gloves depending on their specific end uses.

Generally, disposable gloves can be manufactured by a dipping process or a stamping process. The dipping process would employ a three-dimensional hand shaped mold which is introduced into a forming liquid compound. A portion of the forming liquid compound would adhere to the hand shaped mold to produce a thin layer of film thereon. After solidification, the thin layer film would be stripped from the mold, thereby producing a glove. The dipping process usually employs plastic and rubber polymers, such as polyvinyl chloride (PVC), natural rubber latex (NRL), or synthetic latex. Dipped gloves are mainly used for medical and surgical uses, and have good fitting characteristic resulting from effective elasticity of the materials. However, these materials suffer certain disadvantages including safety (for example, allergic reaction) and environmental concerns. In addition, it is very difficult to dip films at a thickness less than 0.5 mm without compromising film integrity.

The majority of disposable gloves used for the food industry are produced by a stamping process. Two films made from polymers would be laid upon each other on a flat surface. Then, a metallic hand shaped knife would be applied to the top of the first film to cut through both film layers. Since the hand shaped knife is also heated, the layers would be welded together along the cutting line as the films are cut to form one glove. A common material used for disposable gloves produced by this process is polyethylene, typically a mixture thereof, due to low cost, inertness of the materials to a wide range of chemicals, and flexibility of the gloves over a wide range of temperatures. While enjoying the above desired properties, the disposable gloves made from polyethylene polymers may however fail to meet certain requirements. For example, compared to dipped PVC gloves, these gloves may be thinner but are not very comfortable to wear and much less fitting to the user's hand, and may also easily tear.

European Patent No. 0 500 590 discloses microtextured elastomeric laminates comprising at least one elastomeric layer and at least one thin skin layer is preferably prepared by coextrusion of the layers followed by stretching the laminate past the elastic limit of the skin layers and then allowing the laminate to recover.

European Patent No. 1,581,390 relates to an article which includes a low crystallinity layer and a high crystallinity layer capable of undergoing plastic deformation upon elongation. The low crystallinity layer includes a low crystallinity polymer and optionally, an additional polymer. The high crystallinity layer includes a high crystallinity polymer having a melting point of at least 25° C. higher than that of the low crystallinity polymer. The low crystallinity polymer and the high crystallinity polymer can have compatible crystallinity. This patent also includes an article which includes a low crystallinity layer and a plastically deformed high crystallinity layer.

U.S. Pat. No. 8,572,765 provides a single use disposable glove utilizing a stamping process. The various layers of the glove are produced from an extrusion process made from a variety of materials including, but not limited to, polyvinyl chloride, polystyrene, polyurethane, polybutene, styrene-butadiene copolymers, ethylene-propylene copolymers, their mixtures and blends.

U.S. Patent Publication No. 2013/0067637 relates to disposable gloves, ethylene-based thermoplastic materials for use in preparing disposable gloves, and methods for preparing ethylene-based thermoplastic materials for use in preparing disposable gloves. Generally, this patent application relates to non-medical and non-surgical disposable gloves suitable for use in food-service and industrial applications. In particular, this patent application is directed to disposable gloves including, a coloring agent incorporated into one or more of the ethylene-based polymer layers to indicate, for example, the size of the glove, the right- or left-handedness of the glove, and/or the presence of one or more additives (e.g., an antibacterial agent).

While conventional gloves, such as those made from PVC and polyethylene, have proven effective for certain applications, there remains a need for alternatives that can overcome above-noted drawbacks, for example, by providing use comfort and fitting characteristic similar to those of PVC gloves with safe and environmental-friendly materials. Applicant has found that such objective can be achieved by applying a propylene-based elastomer, preferably to a polyethylene film, to produce gloves. As a result of its elastic nature, addition of the propylene-based elastomer can substantially improve use comfort and fitting characteristic of polyethylene gloves to a level comparable to PVC gloves, while maintaining or even optimizing other properties at desired levels. This combination of advantages from both PVC and polyethylene gloves would make the inventive glove well suited for a much broadened range of glove applications.

### SUMMARY OF THE INVENTION

Provided are gloves comprising a propylene-based elastomer and methods for making them.

In one embodiment, the present invention encompasses a glove comprising a film comprising a core layer, wherein the core layer comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g.

In another embodiment, the present invention relates to a method for making a glove, comprising the steps of: (a) preparing a film comprising a core layer, wherein the core layer comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g; and (b) forming a glove comprising the film in step (a).

Preferably, the film further comprises an outer layer at each side of the core layer. Preferably, at least one outer layer comprises a polyethylene.

Also provided is a glove, comprising a multilayer film comprising three layers, wherein the film comprises: (a) two outer layers, each comprising a polyethylene present in amount of at least about 35 wt %, based on total weight of polymer in each such outer layer; and (b) a core layer between the two outer layers, comprising a propylene-based elastomer present in an amount of at least about 30 wt %, based on total weight of polymer in the core layer, wherein the propylene-based elastomer comprises at least about 60 wt % propylene-derived units and about 3 to about 25 wt % ethylene-derived units, based on the total weight of the propylene-based elastomer, wherein the propylene-based elastomer has a heat of fusion of less than about 80 J/g: wherein the two outer layers are identical, and the thickness ratio between each outer layer and the core layer is about 1:3 to about 1:5.

Preferably, the film above has at least one of the following properties: (i) a hysteresis (EMC method) of up to 10% lower than that of a comparative PVC glove film; (ii) a tear strength in the Machine Direction (MD) of at least about 70% higher than that of a comparative PVC glove film and in the Transverse Direction (TD) of at least about 220% higher than that of a comparative PVC glove film; (iii) a puncture resistance of up to about 75% higher than that of a comparative PVC glove film; and (iv) a tensile strength of at least about 15% higher than that of a comparative PVC glove film.

### BRIEF DESCRIPTION OF THE DRAWINGS

FIG. 1 depicts a schematic representation of film structures for each of the film samples in Example 1.

FIG. 2 depicts hysteresis for each of the film samples in Example 1.

FIG. 3 depicts tear strength for each of the film samples in Example 1.

FIG. 4 depicts puncture resistance for each of the film samples in Examples 1 and 2.

FIG. 5 depicts tensile strength for each of the film samples in Example 1.

FIG. 6 depicts softness for each of the film samples in Examples 1 and 2.

FIG. 7 depicts hermeticity for each of the glove samples in Example 1.

### DETAILED DESCRIPTION OF THE PRESENT INVENTION

Various specific embodiments, versions of the present invention will now be described, including preferred embodiments and definitions that are adopted herein. While the following detailed description gives specific preferred embodiments, those skilled in the art will appreciate that these embodiments are exemplary only, and that the present invention can be practiced in other ways. Any reference to the “invention” may refer to one or more, but not necessarily all, of the present inventions defined by the claims. The use of headings is for purposes of convenience only and does not limit the scope of the present invention.

As used herein, a “polymer” may be used to refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like. Thus, as used herein, the terms “polyethylene,” “ethylene polymer,” “ethylene copolymer,” and “ethylene based polymer” mean a polymer or copolymer comprising at least 50 mol % ethylene units (preferably at least 70 mol % ethylene units, more preferably at least 80 mol % ethylene units, even more preferably at least 90 mol % ethylene units, even more preferably at least 95 mol % ethylene units or 100 mol % ethylene units (in the case of a homopolymer)). Furthermore, the term “polyethylene” may also refer to a composition containing one or more polyethylene components.

As used herein, when a polymer is referred to as comprising a monomer, the monomer is present in the polymer in the polymerized form of the monomer or in the derivative form of the monomer.

As used herein, when a polymer is said to comprise a certain percentage, wt %, of a monomer, that percentage of monomer is based on the total amount of monomer units in the polymer.

As used herein, “elastomer” or “elastomeric composition” refers to any polymer or composition of polymers (such as blends of polymers) consistent with the ASTM D1566 definition. Elastomer includes mixed blends of polymers such as melt mixing and/or reactor blends of polymers.

For purposes of this invention and the claims thereto, an ethylene polymer having a density of 0.86 g/cm³ or less is referred to as an ethylene elastomer: an ethylene polymer having a density of more than 0.86 to less than 0.910 g/cm³ is referred to as an ethylene plastomer; an ethylene polymer having a density of 0.910 to 0.940 g/cm³ is referred to as a low density polyethylene (LDPE); and an ethylene polymer having a density of more than 0.940 g/cm³ is referred to as a high density polyethylene (HDPE).

Polyethylene having a density of 0.890 to 0.930 g/cm³, typically from 0.915 to 0.930 g/cm³, that is linear and does not contain long chain branching is referred to as “linear low density polyethylene” (LLDPE) and can be produced with conventional Ziegler-Natta catalysts, vanadium catalysts, or with metallocene catalysts in gas phase reactors and/or in slurry reactors and/or with any of the disclosed catalysts in solution reactors. “Linear” means that the polyethylene has no or only a few long chain branches, typically referred to as a g'vis of 0.97 or above, preferably 0.98 or above.

As used herein, “core” layer. “outer” layer and “inner” layer are merely identifiers used for convenience, and shall not be construed as limitation on individual layers, their relative positions, or the laminated structure, unless otherwise specified.

As used herein, film layers that are the same in composition and in thickness are referred to as “identical” layers.

As used herein, “hysteresis” refers to the increase in length, expressed as a percentage of the original length, by which an elastic material fails to return to original length after stretching. As used herein, the hysteresis is measured herein using a Zwick Z010TN after samples with a width of 50 mm are conditioned in the constant temperature lab for at least 40 hours at a temperature of 23° C.±2° C. and at a relative humidity of 50%±10%. The sample is stretched two times to 100% elongation at a cross-head speed of 500 mm/min. Then after one second, the cross-head returns to its starting position at the same cross-head speed. After 30 seconds, back at the starting position, the percent elongation reached at a load of 0.1N is measured. This method is specifically developed by Applicant and is herein referred to as “EMC method”.

The present invention relates to a glove comprising a film comprising a core layer, wherein the core layer comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g. Preferably, the film further comprises an outer layer at each side of the core layer. Preferably, at least one outer layer comprises a polyethylene.

### Propylene-Based Elastomers

The glove of the present invention comprises a film comprising a core layer, wherein the core layer comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g. Preferably, the propylene-based elastomer is present in an amount of at least about 30 wt %, for example, in an amount of anywhere from a lower limit of 30, 40, 50, or 60 wt %, to an upper limit of 70, 80, 90, or 100 wt %, based on total weight of polymer in the core layer. Most preferably, the propylene-based elastomer is present in an amount of 100 wt %, based on total weight of polymer in the core layer.

The propylene-based elastomer is a copolymer of propylene-derived units and units derived from at least one of ethylene or a C₄-C₁₀ alpha-olefin. The propylene-based elastomer may contain at least about 50 wt % propylene-derived units. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The amount of propylene-derived units present in the propylene-based elastomer may range from an upper limit of about 95 wt %, about 94 wt %, about 92 wt %, about 90 wt %, or about 85 wt %, to a lower limit of about 60 wt %, about 65 wt %, about 70 wt %, about 75 wt %, about 80 wt %, about 84 wt %, or about 85 wt % of the propylene-based elastomer.

The units or comonomers derived from at least one of ethylene or a C₄-C₁₀ alpha-olefin may be present in an amount of about 1 to about 35 wt %, or about 5 to about 35 wt %, or about 7 to about 30 wt %, or about 8 to about 25 wt %, or about 8 to about 20 wt %, or about 8 to about 18 wt %, of the propylene-based elastomer. The comonomer content may be adjusted so that the propylene-based elastomer has a heat of fusion of less than about 80 J/g, a melting point of about 105° C. or less, and a crystallinity of about 2% to about 65% of the crystallinity of isotactic polypropylene, and a fractional melt flow rate (MFR) of about 2 to about 20 g/10 min.

In preferred embodiments, the comonomer is ethylene, 1-hexene, or 1-octene, with ethylene being most preferred. In embodiments where the propylene-based elastomer comprises ethylene-derived units, the propylene-based elastomer may comprise about 3 to about 25 wt %, or about 5 to about 20 wt, or about 9 to about 16 wt % of ethylene-derived units. In some embodiments, the propylene-based elastomer consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the heat of fusion, melting point, crystallinity, or fractional melt flow rate of the propylene-based elastomer, or in an amount such that any other comonomer is intentionally added to the polymerization process.

In some embodiments, the propylene-based elastomer may comprise more than one comonomer. Preferred embodiments of a propylene-based elastomer having more than one comonomer include propylene-ethylene-octene, propylene-ethylene-hexene, and propylene-ethylene-butene polymers. In embodiments where more than one comonomer derived from at least one of ethylene or a C₄-C₁₀ alpha-olefin is present, the amount of one comonomer may be less than about 5 wt % of the propylene-based elastomer, but the combined amount of comonomers of the propylene-based elastomer is about 5 wt % or greater.

The propylene-based elastomer may have a triad tacticity of three propylene units, as measured by ¹³C NMR of at least about 75%, at least about 80%, at least about 82%, at least about 85%, or at least about 90%. Preferably, the propylene-based elastomer has a triad tacticity of about 50 to about 99, or about 60 to about 99%, or about 75 to about 99%, or about 80 to about 99%. In some embodiments, the propylene-based elastomer may have a triad tacticity of about 60 to 97%.

The propylene-based elastomer has a heat of fusion (“H_{f}”), as determined by DSC, of about 80 J/g or less, or about 70 J/g or less, or about 50 J/g or less, or about 40 J/g or less. The propylene-based elastomer may have a lower limit H_{f} of about 0.5 J/g, or about 1 J/g, or about 5 J/g. For example, the H_{f} value may range from a lower limit of about 1.0, 1.5, 3.0, 4.0, 6.0, or 7.0 J/g, to an upper limit of about 35, 40, 50, 60, 70, 75, or 80 J/g.

The propylene-based elastomer may have a percent crystallinity, as determined according to the DSC procedure described herein, of about 2 to about 65%, or about 0.5 to about 40%, or about 1 to about 30%, or about 5 to about 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25 to about 25%, or in the range of about 0.5 to about 22% of the crystallinity of isotactic polypropylene.

Embodiments of the propylene-based elastomer may have a tacticity index m/r from a lower limit of about 4, or about 6, to an upper limit of about 8, or about 10, or about 12. In some embodiments, the propylene-based elastomer has an isotacticity index greater than 0%/o, or within the range having an upper limit of about 50%, or about 25%, and a lower limit of about 3%, or about 10%.

In some embodiments, the propylene-based elastomer may further comprise diene-derived units (as used herein, “diene”). The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkyliene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of about 15%, about 10%, about 70%, about 5%, about 4.5%, about 3%, about 2.5%, or about 1.5%, to a lower limit of about 0%, about 0.1%, about 0.2%, about 0.3%, about 0.5%, about 1%, about 3%, or about 5%, based on the total weight of the propylene-based elastomer.

The propylene-based elastomer may have a single peak melting transition as determined by DSC. In some embodiments, the copolymer has a primary peak transition of about 90° C. or less, with a broad end-of-melt transition of about 110° C. or greater. The peak “melting point” (“Tₘ”) is defined as the temperature of the greatest heat absorption within the range of melting of the sample. However, the copolymer may show secondary melting peaks adjacent to the principal peak, and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of about 110° C. or less, about 105° C. or less, about 100° C. or less, about 90° C. or less, about 80° C. or less, or about 70° C. or less. In some embodiments, the propylene-based elastomer has a Tₘ of about 25 to about 105° C., or about 60 to about 105° C., or about 70 to about 105° C., or about 75 to about 102° C.

The propylene-based elastomer may have a density of about 0.850 to about 0.900 g/cm³, or about 0.860 to about 0.880 g/cm³, at room temperature as measured by ASTM D1505.

The propylene-based elastomer may have a fractional MFR, as measured based on ASTM D1238, 2.16 kg at 230° C., of at least about 0.5 g/10 min. In some embodiments, the propylene-based elastomer may have a fractional MFR of about 0.5 to about 20 g/10 min, or about 2 to about 20 g/10 min, or about 2 to about 10 g/10 min.

The propylene-based elastomer may have an Elongation at Break of less than about 2000%, less than about 1800%, less than about 1500%, or less than about 1000%, as measured based on ASTM D638.

The propylene-based elastomer may have a weight average molecular weight (M_{w}) of about 5,000 to about 5,000,000 g/mole, or about 10,000 to about 1,000,000 g/mole, or about 50,000 to about 400,000 g/mole. The propylene-based elastomer may have a number average molecular weight (Mₙ) of about 2,500 to about 250,000 g/mole, or about 10,000 to about 250,000 g/mole, or about 25,000 to about 250,000 g/mole. The propylene-based elastomer may have a z-average molecular weight (M_{z}) of about 10,000 to about 7,000,000 g/mole, or about 80,000 to about 700,000 g/mole, or about 100,000 to about 500,000 g/mole.

The propylene-based elastomer may have a molecular weight distribution (“MWD”) of about 1.5 to about 20, or about 1.5 to about 15, or about 1.5 to about 5, or about 1.8 to about 3, or about 1.8 to about 2.5.

In some embodiments, the propylene-based elastomer is an elastomer including propylene-crystallinity, a melting point by DSC equal to or less than 105° C., and a heat of fusion of from about 5 J/g to about 45 J/g. The propylene-derived units are present in an amount of about 80 to about 90 wt %, based on the total weight of the propylene-based elastomer. The ethylene-derived units are present in an amount of about 8 to about 18 wt %, for example, about 8, about 8.5, about 9, about 9.5, about 10, about 10.5, about 11, about 11.5, about 12, about 12.5, about 13, about 13.5, about 14 about 14.5, about 15, about 15.5, about 16, about 16.5, about 17, about 17.5, about 18 wt %, based on the total weight of the propylene-based elastomer.

In a preferred embodiment, the film used for the glove described herein further comprises an outer layer at each side of the core layer. Preferably, at least one outer layer comprises a polyethylene. The outer layer may further comprise the propylene-based elastomer described herein, preferably in an amount of no more than 65 wt %, based on total weight of polymer in such outer layer. The propylene-based elastomer present in the outer layer may be the same as or different from the one present in the core layer.

The core layer and optionally at least one outer layer (if present) of the film described herein may each include a composition of one or more different propylene-based elastomers in the core layer, i.e., propylene-based elastomers each having one or more different properties such as, for example, different comonomer or comonomer content. The compositions of one or more propylene-based elastomers in the core layer and at least one outer layer (if present) may be the same as or different. Such compositions of various propylene-based elastomers are all within the scope of the invention.

Suitable propylene-based elastomers may be available commercially under the trade names VISTAMAXX™ (ExxonMobil Chemical Company, Houston, Tex., USA), VERSIFY™ (The Dow Chemical Company. Midland, Mich., USA), certain grades of TAFMER™ XM or NOTIO™ (Mitsui Company, Japan), and certain grades of SOFTEL™ (Basell Polyolefins of the Netherlands). The particular grade(s) of commercially available propylene-based elastomer suitable for use in the invention can be readily determined using methods commonly known in the art.

It has been discovered that use of the propylene-based elastomer described herein in a specific layer of a film to prepare a glove can particularly assist in achieving desired alternatives to the conventional PVC and polyethylene gloves. Especially, when the propylene-based elastomer is introduced into a specific layer of a film made from polyethylene to prepare a glove, compared to a polyethylene glove not containing the propylene-based elastomer, the use comfort and fitting characteristic may be significantly enhanced to a level comparable to PVC gloves, without the safety and environmental concerns caused by PVC materials, while other properties, such as tear strength and puncture resistance, may be maintained at or even increased to desired levels. This improvement may be attributed to the semi-crystal polymer structure of the propylene-based elastomer, which provides high amorphous content and adequate isotactic propylene microcrystalline regions leading to good elasticity.

### Ethylene Polymers

In addition to the propylene-based elastomer, the film described herein may further comprise a polyethylene in the core layer, preferably in an amount of no more than about 70 wt %, no more than about 60 wt %, no more than about 50 wt %, no more than about 40 wt %, no more than about 30 wt %, no more than about 20 wt %, or no more than about 10 wt %, based on total weight of polymer in the core layer, to prepare the glove of the present invention.

In one preferred embodiment, the film described herein further comprises an outer layer at each side of the core layer. Preferably, at least one outer layer comprises a polyethylene. The outer layer may comprise the polyethylene in amount of at least about 35 wt %, for example, in an amount of anywhere from a lower limit of 35, 40, 45, 50, 55, 60, or 65 wt %, to an upper limit of 75, 80, 85, 90, 95, or 100 wt %, based on total weight of polymer in such outer layer.

In one aspect of the invention, the ethylene polymers that can be used for the film described herein are selected from ethylene homopolymers, ethylene copolymers, and compositions thereof. Useful copolymers comprise one or more comonomers in addition to ethylene and can be a random copolymer, a statistical copolymer, a block copolymer, and/or compositions thereof. The method of making the polyethylene is not critical, as it can be made by slurry, solution, gas phase, high pressure or other suitable processes, and by using catalyst systems appropriate for the polymerization of polyethylenes, such as Ziegler-Natta-type catalysts, chromium catalysts, metallocene-type catalysts, other appropriate catalyst systems or combinations thereof, or by free-radical polymerization. In a preferred embodiment, the ethylene polymers are made by the catalysts, activators and processes described in U.S. Pat. Nos. 6,342,566; 6,384,142; and 5,741,563; and PCT Publication Nos. WO 03/040201 and WO 97/19991. Such catalysts are well known in the art, and are described in, for example, ZIEGLER CATALYSTS (Gerhard Fink, Rolf Mühaupt and Hans H. Brintzinger, eds., Springer-Verlag 1995); Resconi et al.; and I, II METALLOCENE-BASED POLYOLEFINS (Wiley & Sons 2000).

Ethylene polymers and copolymers that are useful in this invention include those sold by ExxonMobil Chemical Company in Houston Tex., including HDPE, LLDPE, and LDPE; and those sold under the ENABLE™, EXACT™, EXCEED™, ESCORENE™, EXXCO™, ESCOR™, PAXON™, and OPTEMA™ trade names.

Preferred ethylene homopolymers and copolymers useful in this invention typically have:

1. an M_{w} of 20,000 g/mol or more, 20,000 to 2,000,000 g/mol, preferably 30,000 to 1,000,000, preferably 40,000 to 200,000, preferably 50,000 to 750.000, as measured by size exclusion chromatography; and/or

2. an M_{w}/Mₙ of 1 to 40, preferably 1.6 to 20, or 8 to 25, more preferably 1.8 to 10, more preferably 1.8 to 4, as measured by size exclusion chromatography; and/or

3. a Tₘ of 30° C. to 150° C., preferably 30° C. to 140° C., preferably 50° C. to 140° C. more preferably 60° C. to 135° C., as determined based on ASTM D3418-03; and/or

4. a crystallinity of 5% to 80%, preferably 10% to 70%, more preferably 20% to 60%, preferably at least 30%, or at least 40%, or at least 50%, as determined based on ASTM D3418-03; and/or

5. a heat of fusion of 300 J/g or less, preferably 1 to 260 J/g, preferably 5 to 240 J/g, preferably 10 to 200 J/g, as determined based on ASTM D3418-03; and/or

6. a crystallization temperature (T_{c}) of 15° C. to 130° C., preferably 20° C. to 120° C. more preferably 25° C. to 110° C., preferably 60° C. to 125° C., as determined based on ASTM D3418-03; and/or

7. a heat deflection temperature of 30° C. to 120° C., preferably 40° C. to 100° C., more preferably 50° C. to 80° C. as measured based on ASTM D648 on injection molded flexure bars, at 66 psi load (455 kPa); and/or

8. a Shore hardness (D scale) of 10 or more, preferably 20 or more, preferably 30 or more, preferably 40 or more, preferably 100 or less, preferably from 25 to 75 (as measured based on ASTM D 2240); and/or

9. a percent amorphous content of at least 50%, preferably at least 60%, preferably at least 70%, more preferably between 50% and 95%, or 70% or less, preferably 60% or less, preferably 50% or less as determined by subtracting the percent crystallinity from 100; and/or

10. a branching index (g'vis) of 0.97 or more, preferably 0.98 or more, preferably 0.99 or more, preferably 1; and/or

11. a density of about 0.860 to about 0.980 g/cm³ (preferably from 0.880 to 0.960 g/cm³, preferably from 0.910 to 0.940 g/cm³, preferably from 0.915 to 0.930 g/cm³) determined based on ASTM D 1505 using a density-gradient column on a compression-molded specimen that has been slowly cooled to room temperature (i.e., over a period of 10 minutes or more) and allowed to age for a sufficient time that the density is constant within +/−0.001 g/cm³.

The polyethylene may be an ethylene homopolymer, such as HDPE. In one embodiment, the ethylene homopolymer has a molecular weight distribution (M_{w}/Mₙ) of up to 40, preferably ranging from 1.5 to 20, or from 1.8 to 10, or from 1.9 to 5, or from 2.0 to 4. In another embodiment, the 1% secant flexural modulus (determined based on ASTM D790A, where test specimen geometry is as specified under the ASTM D790 section “Molding Materials (Thermoplastics and Thermosets),” and the support span is 2 inches (5.08 cm)) of the ethylene polymer falls in a range of 200 to 1000 MPa, and from 300 to 800 MPa in another embodiment, and from 400 to 750 MPa in yet another embodiment, wherein a desirable polymer may exhibit any combination of any upper flexural modulus limit with any lower flexural modulus limit. The melt index (MI) of preferred ethylene homopolymers range from 0.05 to 800 dg/min in one embodiment, and from 0.1 to 100 dg/min in another embodiment, as measured based on ASTM D1238 (190° C., 2.16 kg).

In a preferred embodiment, the polyethylene comprises less than 20 mol % propylene units (preferably less than 15 mol %, preferably less than 10 mol %, preferably less than 5 mol %, and preferably 0 mol % propylene units).

In another embodiment of the invention, the ethylene polymer useful herein is produced by polymerization of ethylene and, optionally, an alpha-olefin with a catalyst having, as a transition metal component, a bis(n-C₃₋₄ alkyl cyclopentadienyl) hafnium compound, wherein the transition metal component preferably comprises from about 95 mol % to about 99 mol % of the hafnium compound as further described in U.S. Pat. No. 9,956,088.

In another embodiment of the invention, the ethylene polymer is an ethylene copolymer, either random or block, of ethylene and one or more comonomers selected from C₃ to C₂₀ α-olefins, typically from C₃ to C₁₀ α-olefins. Preferably, the comonomers are present from 0.1 wt % to 50 wt % of the copolymer in one embodiment, and from 0.5 wt % to 30 wt % in another embodiment, and from 1 wt % to 15 wt % in yet another embodiment, and from 0.1 wt % to 5 wt % in yet another embodiment, wherein a desirable copolymer comprises ethylene and C₃ to C₂₀ α-olefin derived units in any combination of any upper wt % limit with any lower wt % limit described herein. Preferably the ethylene copolymer will have a weight average molecular weight of from greater than 8,000 g/mol in one embodiment, and greater than 10,000 g/mol in another embodiment, and greater than 12,000 g/mol in yet another embodiment, and greater than 20,000 g/mol in yet another embodiment, and less than 1,000,000 g/mol in yet another embodiment, and less than 800,000 g/mol in yet another embodiment, wherein a desirable copolymer may comprise any upper molecular weight limit with any lower molecular weight limit described herein.

In another embodiment, the ethylene copolymer comprises ethylene and one or more other monomers selected from the group consisting of C₃ to C₂₀ linear, branched or cyclic monomers, and in some embodiments is a C₃ to C₁₂ linear or branched alpha-olefin, preferably butene, pentene, hexene, heptene, octene, nonene, decene, dodecene, 4-methyl-pentene-1,3-methyl pentene-1,3,5,5-trimethyl-hexene-1, and the like. The monomers may be present at up to 50 wt %, preferably from 0 wt % to 40 wt %, more preferably from 0.5 wt % to 30 wt %, more preferably from 2 wt % to 30 wt %, more preferably from 5 wt % to 20 wt %, based on the total weight of the ethylene copolymer.

Preferred linear alpha-olefins useful as comonomers for the ethylene copolymers useful in this invention include C₃ to C₈ alpha-olefins, more preferably 1-butene, 1-hexene, and 1-octene, even more preferably 1-hexene. Preferred branched alpha-olefins include 4-methyl-1-pentene, 3-methyl-1-pentene, 3,5,5-trimethyl-1-hexene, and 5-ethyl-1-nonene. Preferred aromatic-group-containing monomers contain up to 30 carbon atoms. Suitable aromatic-group-containing monomers comprise at least one aromatic structure, preferably from one to three, more preferably a phenyl, indenyl, fluorenyl, or naphthyl moiety. The aromatic-group-containing monomer further comprises at least one polymerizable double bond such that after polymerization, the aromatic structure will be pendant from the polymer backbone. The aromatic-group containing monomer may further be substituted with one or more hydrocarbyl groups including but not limited to C₁ to C₁₀ alkyl groups. Additionally, two adjacent substitutions may be joined to form a ring structure. Preferred aromatic-group-containing monomers contain at least one aromatic structure appended to a polymerizable olefinic moiety. Particularly, preferred aromatic monomers include styrene, alpha-methylstyrene, para-alkylstyrenes, vinyltoluenes, vinylnaphthalene, allyl benzene, and indene, especially styrene, paramethyl styrene, 4-phenyl-1-butene and allyl benzene.

Preferred diolefin monomers useful in this invention include any hydrocarbon structure, preferably C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (M_{w} less than 1000 g-mol). Preferred cyclic dienes include cyclopentadiene, vinylnorbornene, norbornadiene, ethylidene norbornene, divinylbenzene, dicyclopentadiene, or higher ring containing diolefins with or without substituents at various ring positions.

In a preferred embodiment, one or more dienes are present in the ethylene polymer at up to 10 wt %, preferably at 0.00001 wt % to 2 wt %, preferably 0.002 wt % to 1 wt %, even more preferably 0.003 wt % to 0.5 wt %, based upon the total weight of the ethylene polymer. In some embodiments diene is added to the polymerization in an amount of from an upper limit of 500 ppm, 400 ppm, or 300 ppm to a lower limit of 50 ppm, 100 ppm, or 150 ppm.

Preferred ethylene copolymers useful herein are preferably a copolymer comprising at least 50 wt % ethylene and having up to 50 wt %, preferably 1 wt % to 35 wt %, even more preferably 1 wt % to 6 wt % of a C₃ to C₂₀ comonomer, preferably a C₄ to C₈ comonomer, preferably hexene or octene, based upon the weight of the copolymer. The polyethylene copolymers preferably have a composition distribution breadth index (CDBI) of 60% or more, preferably 60% to 80%, preferably 65% to 80%. In another preferred embodiment, the ethylene copolymers have a CDBI of 60% to 80%, preferably between 65% and 80%. Preferably these polymers are metallocene polyethylenes (mPEs).

Useful mPE homopolymers or copolymers may be produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. Several commercial products produced with such catalyst/activator combinations are commercially available from ExxonMobil Chemical Company in Houston, Tex. under the trade name EXCEED™ polyethylene or ENABLE™ polyethylene.

In a preferred embodiment, the polyethylene described herein present in at least one outer layer may be physical blends or in situ blends of more than one type of ethylene polymer or compositions of ethylene polymers with polymers other than ethylene polymers where the ethylene polymer component is the majority component, e.g., greater than 50 wt % of the total weight of the composition. In another embodiment, the film can also comprise in the core the polyethylene described herein, preferably in the form of a blend of two polyethylenes. Preferably, the polyethylene in at least one outer layer and the core layer is a blend of two polyethylenes with different densities. The weight ratio between the polyethylene of a higher density and the polyethylene of a lower density may be about 1:3 to about 3:1, for example, about 1:3, about 1:2, about 1:1, about 2:1, or about 3:1.

### Additives

The film used for the glove described herein may also contain various additives as is generally known in the art in the core layer and at least one outer layer (if present). Examples of such additives include a slip agent, an anti block, a filler, an antioxidant, an ultraviolet light stabilizer, a thermal stabilizer, a pigment, a processing aid, a crosslinking catalyst, a flame retardant, and a foaming agent, etc. In a preferred embodiment, the additives may each individually present at 0.01 wt % to 50 wt %, or from 0.01 wt % to 10 wt %, or from 0.1 wt % to 6 wt %, based upon the weight of the film layer. Preferably, the film described herein comprises two outer layers each including a slip agent and an anti block to control the coefficient of friction and deliver desired winding and unwinding properties during film preparation. Additives may also impact sealing property of the formed glove.

### Films, Gloves and Methods for Making the Gloves

The present invention also relates to a method for making a glove, comprising the steps of: (a) preparing a film comprising a core layer, wherein the core layer comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g; and (b) forming a glove comprising the film in step (a).

The propylene-based elastomer and the polyethylene described above may be formed into films comprising a core layer, i.e. monolayer or multilayer films. These films may be formed by any of the conventional techniques known in the art including blown extrusion, cast extrusion, coextrusion, blow molding, casting, and extrusion blow molding.

In multilayer constructions, the film may further comprise additional layer(s), which may be any layer typically included in multilayer film structures. For example, the additional layer(s) may be made from:
1. Polyolefins. Preferred polyolefins include homopolymers or copolymers of C₂ to C₄₀ olefins, preferably C₂ to C₂₀ olefins, preferably a copolymer of an α-olefin and another olefin or α-olefin (ethylene is defined to be an α-olefin for purposes of this invention). Preferably homopolyethylene, homopolypropylene, propylene copolymerized with ethylene and/or butene, ethylene copolymerized with one or more of propylene, butene or hexene, and optional dienes. Preferred examples include thermoplastic polymers such as ultra-low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and compositions of thermoplastic polymers and elastomers, such as, for example, thermoplastic elastomers and rubber toughened plastics.

2. Polar polymers. Preferred polar polymers include homopolymers and copolymers of esters, amides, acetates, anhydrides, copolymers of a C₂ to C₂₀ olefin, such as ethylene and/or propylene and/or butene with one or more polar monomers, such as acetates, anhydrides, esters, alcohol, and/or acrylics. Preferred examples include polyesters, polyamides, ethylene vinyl acetate copolymers, and polyvinyl chloride.

3. Cationic polymers. Preferred cationic polymers include polymers or copolymers of geminally disubstituted olefins, α-heteroatom olefins and/or styrenic monomers. Preferred geminally disubstituted olefins include isobutylene, isopentene, isoheptene, isohexane, isooctene, isodecene, and isododecene. Preferred α-heteroatom olefins include vinyl ether and vinyl carbazole, preferred styrenic monomers include styrene, alkyl styrene, para-alkyl styrene, α-methyl styrene, chloro-styrene, and bromo-para-methyl styrene. Preferred examples of cationic polymers include butyl rubber, isobutylene copolymerized with para methyl styrene, polystyrene, and poly-α-methyl styrene.

4. Miscellaneous. Other preferred layers can be paper, wood, cardboard, metal, metal foils (such as aluminum foil and tin foil), metallized surfaces, glass (including silicon oxide (SiOₓ) coatings applied by evaporating silicon oxide onto a film surface), fabric, spunbond fibers, and non-wovens (particularly polypropylene spunbond fibers or non-wovens), and substrates coated with inks, dyes, pigments, and the like.

In particular, a multilayer film can also include layers comprising materials such as ethylene vinyl alcohol (EVOH), polyamide (PA), or polyvinylidene chloride (PVDC), so as to obtain barrier performance for the film where appropriate.

In one aspect of the invention, the film described herein may be produced in a stiff oriented form (often referred to as “pre-stretched” by persons skilled in the art) and may be useful for laminating to inelastic materials, such as polyethylene films, biaxially oriented polyester (e.g., polyethylene terephthalate (PET)) films, biaxially oriented polypropylene (BOPP) films, biaxially oriented polyamide (nylon) films, foil, paper, board, or fabric substrates, or may further comprise one of the above substrate films to form a laminate structure.

The films may vary in thickness depending on the intended use and properties of the formed glove. Conveniently the film has a thickness of from 5 to 200 μm, preferably from 10 to 150 μm, and more preferably from 20 to 90 μm. The thickness of each of the outer layers (if present) may be at least 7% of the total thickness, preferably from 10 to 40%. Preferably, the thickness ratio between one of the outer layers and the core layer is about 1:2 to about 1:9, for example, about 1:2, about 1:3, about 1:4, about 1:5, about 1:6, about 1:7, about 1:8, or about 1:9.

The film described herein may have an A/Y/A structure wherein A is an outer layer and Y is the core layer in contact with the outer layer. Suitably one or both outer layers are a skin layer forming one or both film surfaces and can serve as a lamination skin (the surface to be adhered to a substrate film) or a sealable skin (the surface to form a seal). The composition of the A layers may be the same or different, but conform to the limitations set out herein. Preferably, the A layers are identical. The film may have an A/B/X/B/A structure wherein A are outer layers and X represents the core layer and B are inner layers between the core layer and each outer layer. The composition of the B layers may also be the same or different, but conform to the limitations set out herein. The A and B layers may have the same composition or different compositions. Preferably, at least one of the B layers has a different composition with a density higher than that of the A layer.

In one embodiment of the present invention, the films containing the propylene-based elastomer described herein, monolayer or multilayer, may be formed by using casting techniques, such as a chill roll casting process. For example, a composition can be extruded in a molten state through a flat die and then cooled to form a film. As a specific example, cast films can be prepared using a cast film line machine as follows. Pellets of the polymer are melted at a temperature chosen to match the melt viscosity of the particular resin layers. In the case of a multilayer cast film, the two or more different melts are conveyed to a coextrusion adapter that combines the two or more melt flows into a multilayer, coextruded structure. This layered flow is distributed through a single manifold film extrusion die to the desired width. The die gap opening is typically about 0.025 inches (about 600 μm). The material is then drawn down to the final gauge. The material draw down ratio is typically about 21:1 for 0.8 mil (20 μm) films. A vacuum box, edge pinners, air knife, or a combination of the foregoing can be used to pin the melt exiting the die opening to a primary chill roll maintained at about 32° C. The resulting polymer film is collected on a winder. The film thickness can be monitored by a gauge monitor, and the film can be edge trimmed by a trimmer. A typical cast line rate is from about 250 to about 2000 feet (76.2 to about 609.6 m) per minute. One skilled in the art will appreciate that higher rates may be used for similar processes such as extrusion coating. One or more optional treaters can be used to surface treat the film, if desired. Such chill roll casting processes and apparatus are well known in the art, and are described, for example, in The Wiley-Encyclopedia of Packaging Technology, Second Edition, A. L. Brody and K. S. Marsh, Ed., John Wiley and Sons, Inc., New York (1997). Although chill roll casting is one example, other forms of casting may be employed.

In a preferred embodiment, the layer surface of the film describe herein designed to be the inner surface of the glove is treated with an embossing chill roll, which is used for quick cooling for the propylene-based elastomer and providing proper COF required by use comfort and roughness of the glove inner skin for opening convenience. The film described herein can be manufactured using a cast film process where the web of molten polymer exits an extrusion die and is pressed against a embossing roll transferring the emboss pattern to the polymer web to make a resulting film where only one embossed side has the embossed pattern. The film may be subsequently delivered to a winder or roll, or may be fed to another step for further processing.

Additional films may be introduced to combine with the film comprising the propylene-based elastomer described herein to prepare the inventive glove. The multiple films may be combined using the coating/lamination process where the “smooth” side of the film comprising the propylene-based elastomer (i.e., the side not embossed by the embossing roll) is bonded with other films as desired, either before or after the embossing step.

The inventive glove may be made from the film described herein using any method commonly known in the art including but not limited to stamping, blown molding, and shrink molding. Preferably, the glove is prepared by a stamping process as previously described by suitable selection of process conditions, for example, at a stamping temperature of about 200° C. to about 260° C. and a line speed of about 100 to about 180 pieces/min.

In a preferred embodiment, the glove described herein comprises a film having a three-layer A/Y/A structure as above-specified, comprising: (a) two outer layers, each comprising a polyethylene present in amount of at least about 35 wt %, based on total weight of polymer in each such outer layer; and (b) a core layer between the two outer layers, comprising a propylene-based elastomer present in an amount of at least about 30 wt %, based on total weight of polymer in the core layer, wherein the propylene-based elastomer comprises at least about 60 wt % propylene-derived units and about 3 to about 25 wt % ethylene-derived units, based on the total weight of the propylene-based elastomer, wherein the propylene-based elastomer has a heat of fusion of less than about 80 J/g; wherein the two outer layers are identical, and the thickness ratio between each outer layer and the core layer is about 1:3 to about 1:5. Preferably, each of the two outer layers further comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g. Preferably, the core layer further comprises a polyethylene.

In particular, the film above has at least one of the following properties: (i) a hysteresis (EMC method) of up to 10% lower than that of a comparative PVC glove film; (ii) a tear strength in the Machine Direction (MD) of at least about 70% higher than that of a comparative PVC glove film and in the Transverse Direction (TD) of at least about 220% higher than that of a comparative PVC glove film; (iii) a puncture resistance of up to about 75% higher than that of a comparative PVC glove film; and (iv) a tensile strength of at least about 15% higher than that of a comparative PVC glove film.

Other embodiments of the present invention can include:

1. A glove, comprising a film comprising a core layer, wherein the core layer comprises:

a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g.

2. The glove of paragraph 1, wherein the propylene-based elastomer is present in an amount of at least about 30 wt %, based on total weight of polymer in the core layer.

3. The glove of paragraph 1 or 2, wherein the propylene-based elastomer is present in an amount of about 100 wt %, based on total weight of polymer in the core layer.

4. The glove of any of paragraphs 1 to 3, wherein the core layer further comprises a polyethylene.

5. The glove of any of paragraphs 1 to 4, wherein the core layer further comprises at least one of a slip agent, an anti block, a filler, an antioxidant, an ultraviolet light stabilizer, a thermal stabilizer, a pigment, a processing aid, a crosslinking catalyst, a flame retardant, and a foaming agent.

6. The glove of any of paragraphs 1 to 5, wherein the film further comprises an outer layer at each side of the core layer.

7. The glove of paragraph 6, wherein at least one outer layer comprises a polyethylene.

8. The glove of paragraph 7, where the outer layer comprises the polyethylene in an amount of at least about 35 wt %, based on total weight of polymer in such outer layer.

9. The glove of paragraph 7 or 8, wherein at least one outer layer further comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g.

10. The glove of any of paragraphs 7 to 9, wherein at least one outer layer further comprises at least one of a slip agent, an anti block, a filler, an antioxidant, an ultraviolet light stabilizer, a thermal stabilizer, a pigment, a processing aid, a crosslinking catalyst, a flame retardant, and a foaming agent.

11. The glove of any of paragraphs 6 to 10, wherein the outer layers at each side of the core layers are identical.

12. The glove of any of paragraphs 6 to 11, wherein the thickness ratio between one of the outer layers and the core layer is about 1:2 to about 1:9.

13. The glove of any of paragraphs 1 to 12, wherein the film comprises three layers.

14. A glove, comprising a multilayer film comprising three layers, wherein the film comprises:
(a) two outer layers, each comprising a polyethylene present in amount of at least about 35 wt %, based on total weight of polymer in each such outer layer; and
(b) a core layer between the two outer layers, comprising a propylene-based elastomer present in an amount of at least about 30 wt %, based on total weight of polymer in the core layer, wherein the propylene-based elastomer comprises at least about 60 wt % propylene-derived units and about 3 to about 25 wt % ethylene-derived units, based on the total weight of the propylene-based elastomer, wherein the propylene-based elastomer has a heat of fusion of less than about 80 J/g;
   wherein the two outer layers are identical, and the thickness ratio between each outer layer and the core layer is about 1:3 to about 1:5.

15. The glove of any of paragraphs 1 to 14, wherein the film has at least one of the following properties: (i) a hysteresis (EMC method) of up to 10% lower than that of a comparative PVC glove film; (ii) a tear strength in the Machine Direction (MD) of at least about 70% higher than that of a comparative PVC glove film and in the Transverse Direction (TD) of at least about 220% higher than that of a comparative PVC glove film: (iii) a puncture resistance of up to about 75% higher than that of a comparative PVC glove film: and (iv) a tensile strength of at least about 15% higher than that of a comparative PVC glove film.

16. The glove of paragraph 14 or 15, wherein each of the two outer layers further comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g.

17. The glove of any of paragraphs 14 to 16, wherein the core layer further comprises a polyethylene.

18. A method for making a glove, comprising the steps of:
(a) preparing a film comprising a core layer, wherein the core layer comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g; and
(b) forming a glove comprising the film in step (a).

19. The method of paragraph 18, wherein the film in step (a) further comprises an outer layer at each side of the core layer.

20. The method of paragraph 19, wherein at least one outer layer comprises a polyethylene.

21. The method of any of paragraphs 18 to 20, wherein the film in step (a) is prepared by blown extrusion, cast extrusion, coextrusion, blow molding, casting, or extrusion blow molding.

22. The method of any of paragraphs 18 to 21, wherein the layer surface of the film designed to be the inner surface of the glove is embossed.

23. The method of any of paragraphs 18 to 22, wherein the glove in step (b) is formed by stamping, blown molding, or shrink molding.

### EXAMPLES

The present invention, while not meant to be limited by, may be better understood by reference to the following examples and tables.

### Example 1

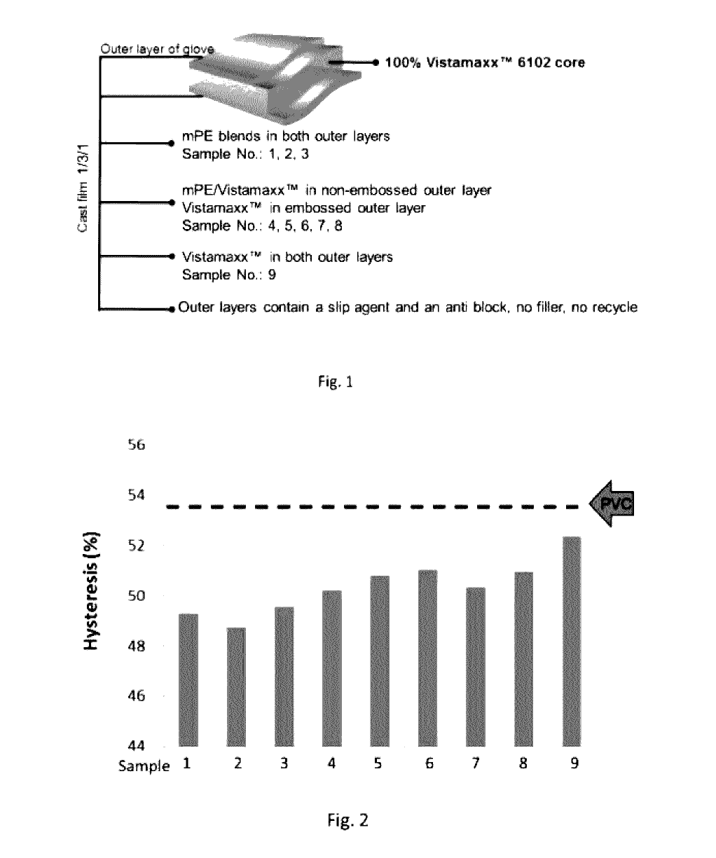

A batch of 19 three-layer films of 40 μm were prepared at a layer distribution ratio of 1:3:1 on a coextrusion cast film line (Xinlehuabao Plastic Machinery Co., Ltd.), 10 of the 19 films (Samples 1-10) were converted into gloves by a stamping process line (Zhangjiagang Xianfeng Automated Machinery Co., Ltd.) at a stamping temperature of about 240° C. and a line speed of about 120 pieces min. VISTAMAXX™ 6102FL propylene-based elastomer (ExxonMobil Chemical Company, Houston, Tex., USA) (ethylene content: 16 wt %. MFR: 3.0 g/10 min) was used in all of Samples 1-10. VISTAMAXX™ 3980FL propylene-based elastomer (ExxonMobil Chemical Company, Houston, Tex. USA) (ethylene content: 9 wt %, MFR: 8.0 g/10 min) was used in Samples 4-10. ENABLE™ 20-10CB mPE resin (ExxonMobil Chemical Company, Houston, Tex., USA) (MI: 1.0 g/10 min, density: 0.920 g/cm³) was used in Samples 1-3 and 6-8. EXCEED™ 3518CB mPE resin (ExxonMobil Chemical Company, Houston, Tex., USA) (MI: 3.5 g/10 min, density: 0.918 g-cm³) was used in Samples 1-6 and 8. COSMOPLENE™ FL7540 polypropylene random copolymer (TPC, the Polyolefin Company, Singapore) was used in Sample 10. The POLYBATCH™ CE 505E slip agent (A. Schulman, Fairlawn, Ohio, USA) and the POLYBATCH™ F15 anti block (A. Schulman, Fairlawn, Ohio, USA) were used in all of Samples 1-10. A comparative PVC glove film as previously defined was provided as control, which was prepared with the same thickness of 40 μm as that of the inventive samples. Structure-wise formulations of Samples 1-10 are listed below in Table 1. A schematic representation of film structures for all the inventive samples is shown in FIG. 1.

TABLE 1
Structure-wise formulation (wt %) for glove film samples of Example 1

| Sample | | | Outer Layer (Non- |
|---|---|---|---|
| No. | Outer Layer (Embossed) | Core Layer | embossed) |
| 1 | EXCEED ™ 3518CB | VISTAMAXX ™ | EXCEED ™ 3518CB |
| | (48) | 6102FL (100) | (48) |
| | ENABLE ™ 20-10CB | | ENABLE ™ 20-10CB |
| | (48) | | (48) |
| | POLYBATCH ™ F15 (2) | | POLYBATCH ™ F15 (2) |
| | POLYBATCH ™ CE | | POLYBATCH ™ CE |
| | 505E (2) | | 505E (2) |
| 2 | EXCEED ™ 3518CB | VISTAMAXX ™ | EXCEED ™ 3518CB |
| | (72) | 6102FL (100) | (72) |
| | ENABLE ™ 20-10CB | | ENABLE ™ 20-10CB |
| | (24) | | (24) |
| | POLYBATCH ™ F15 (2) | | POLYBATCH ™ F15 (2) |
| | POLYBATCH ™ CE | | POLYBATCH ™ CE |
| | 505E (2) | | 505E (2) |
| 3 | EXCEED ™ 3518CB | VISTAMAXX ™ | EXCEED ™ 3518CB |
| | (24) | 6102FL (100) | (24) |
| | ENABLE ™ 20-10CB | | ENABLE ™ 20-10CB |
| | (72) | | (72) |
| | POLYBATCH ™ F15 (2) | | POLYBATCH ™ F15 (2) |
| | POLYBATCH ™ CE | | POLYBATCH ™ CE |
| | 505E (2) | | 505E (2) |
| 4 | VISTAMAXX ™ | VISTAMAXX ™ | EXCEED ™ 3518CB |
| | 3980FL (92) | 6102FL (100) | (72) |
| | POLYBATCH ™ F15 (4) | | VISTAMAXX ™ |
| | POLYBATCH ™ CE | | 3980FL (20) |
| | 505E (4) | | POLYBATCH ™ F15 (4) |
| | | | POLYBATCH ™ CE |
| | | | 505E (4) |
| 5 | VISTAMAXX ™ | VISTAMAXX ™ | EXCEED ™ 3518CB |
| | 3980FL (92) | 6102FL (100) | (52) |
| | POLYBATCH ™ F15 (4) | | VISTAMAXX ™ |
| | POLYBATCH ™ CE | | 3980FL (40) |
| | 505E (4) | | POLYBATCH ™ F15 (4) |
| | | | POLYBATCH ™ CE |
| | | | 505E (4) |
| 6 | VISTAMAXX ™ | VISTAMAXX ™ | ENABLE ™ 20-10CB |
| | 3980FL (92) | 6102FL (100) | (36) |
| | POLYBATCH ™ F15 (4) | | EXCEED ™ 3518CB |
| | POLYBATCH ™ CE | | (36) |
| | 505E (4) | | VISTAMAXX ™ |
| | | | 3980FL (20) |
| | | | POLYBATCH ™ F15 (4) |
| | | | POLYBATCH ™ CE |
| | | | 505E (4) |
| 7 | VISTAMAXX ™ | VISTAMAXX ™ | ENABLE ™ 20-10CB |
| | 3980FL (92) | 6102FL (100) | (52) |
| | POLYBATCH ™ F15 (4) | | VISTAMAXX ™ |
| | POLYBATCH ™ CE | | 3980FL (40) |
| | 505E (4) | | POLYBATCH ™ F15 (4) |
| | | | POLYBATCH ™ CE |
| | | | 505E (4) |
| 8 | VISTAMAXX ™ | VISTAMAXX ™ | ENABLE ™ 20-10CB |
| | 3980FL (92) | 6102FL (100) | (31) |
| | POLYBATCH ™ F15 (4) | | EXCEED ™ 3518CB |
| | POLYBATCH ™ CE | | (31) |
| | 505E (4) | | VISTAMAXX ™ |
| | | | 3980FL (30) |
| | | | POLYBATCH ™ F15 (4) |
| | | | POLYBATCH ™ CE |
| | | | 505E (4) |
| 9 | VISTAMAXX ™ | VISTAMAXX ™ | VISTAMAXX ™ |
| | 3980FL (92) | 6102FL (100) | 3980FL (92) |
| | POLYBATCH ™ F15 (4) | | POLYBATCH ™ F15 (4) |
| | POLYBATCH ™ CE | | POLYBATCH ™ CE |
| | 505E (4) | | 505E (4) |
| 10 | VISTAMAXX ™ | VISTAMAXX ™ | COSMOPLENE ™ |
| | 3980FL (92) | 6102FL (100) | FL7540 (93) |
| | POLYBATCH ™ F15 (4) | | POLYBATCH ™ F15 (3) |
| | POLYBATCH ™ CE | | POLYBATCH ™ CE |
| | 505E (4) | | 505E (4) |

### Example 2

Another batch of 24 three-layer films of 40 μm were prepared and 12 of them (Samples 11-22) were converted into gloves according to the same procedure as described in Example 1. VISTAMAXX™ 6102FL propylene-based elastomer was used in all of Samples 11-22. VISTAMAXX™ 3980FL propylene-based elastomer was used in Samples 16-17 and 19-22. ENABLE™ 20-10CB mPE resin and EXCEED™ 3518CB mPE resin were both used in all of Samples 11-22. The POLYBATCH™ CE 505E slip agent and the POLYBATCH™ F15 anti block were both used in all of Samples 11-22. A calcium carbonate master batch, of which formulation is shown in Table 2, was used in Samples 18, 21 and 22. The same comparative PVC glove film was provided as control. Structure-wise formulations of Samples 11-22 are listed below in Table 3.

TABLE 2
Formulation (wt %) for CaCO₃ Master Batch in Example 2

| | |
|---|---|
| Coated OMYACARB ™ 2T-LU | 84.775 |
| EXXONMOBIL ™ LLDPE LL | 15 |
| 6201XR | |
| IRGANOX ™ 1010 | 0.075 |
| IRGAFOS ™ 168 | 0.15 |

OMYACARB™ 2T—LU calcium carbonate from Omya Group, Switzerland; EXXONMOBIL™ LLDPE LL 6201XR linear low density polyethylene resin from ExxonMobil Chemical Company, Houston, Tex., USA: IRGANOX™ 1010 antioxidant and IRGAFOS™ 168 processing stabilizer from BASF Group, Germany.

TABLE 3
Structure-wise formulations (wt %) for glove film
samples of Example 2

| | | | Layer |
|---|---|---|---|
| Sam- | | | Distribution |
| ple | | | (outer/core/ |
| No. | Both Outer Layers | Core Layer | outer) |
| 11 | EXCEED ™ 3518CB | VISTAMAXX ™ | 1/3/1 |
| | (48) | 6102FL (100) | |
| | ENABLE ™ 20-10CB | | |
| | (48) | | |
| | POLYBATCH ™ F15 (2) | | |
| | POLYBATCH ™ CE | | |
| | 505E (2) | | |
| 12 | EXCEED ™ 3518CB | VISTAMAXX ™ | 1/5/1 |
| | (48) | 6102FL (100) | |
| | ENABLE ™ 20-10CB | | |
| | (48) | | |
| | POLYBATCH ™ F15 (2) | | |
| | POLYBATCH ™ CE | | |
| | 505E (2) | | |
| 13 | EXCEED ™ 3518CB | EXCEED ™ 3518CB | 1/3/1 |
| | (48) | (32) | |
| | ENABLE ™ 20-10CB | ENABLE ™ 20-10CB | |
| | (48) | (32) | |
| | POLYBATCH ™ F15 (2) | VISTAMAXX ™ | |
| | POLYBATCH ™ CE | 6102FL (34) | |
| | 505E (2) | POLYBATCH ™ F15 | |
| | | (1) | |
| | | POLYBATCH ™ CE | |
| | | 505E (1) | |
| 14 | EXCEED ™ 3518CB | EXCEED ™ 3518CB | 1/5/1 |
| | (48) | (19) | |
| | ENABLE ™ 20-10CB | ENABLE ™ 20-10CB | |
| | (48) | (19) | |
| | POLYBATCH ™ F15 (2) | VISTAMAXX ™ | |
| | POLYBATCH ™ CE | 6102FL (60) | |
| | 505E (2) | POLYBATCH ™ F15 | |
| | | (1) | |
| | | POLYBATCH ™ CE | |
| | | 505E (1) | |
| 15 | EXCEED ™ 3518CB | EXCEED ™ 3518CB | 1/3/1 |
| | (48) | (15) | |
| | ENABLE ™ 20-10CB | ENABLE ™ 20-10CB | |
| | (48) | (15) | |
| | POLYBATCH ™ F15 (2) | VISTAMAXX ™ | |
| | POLYBATCH ™ CE | 6102FL (68) | |
| | 505E (2) | POLYBATCH ™ F15 | |
| | | (1) | |
| | | POLYBATCH ™ CE | |
| | | 505E(1) | |
| 16 | EXCEED ™ 3518CB | VISTAMAXX ™ | 1/3/1 |
| | (17) | 6102FL (100) | |
| | ENABLE ™ 20-10CB | | |
| | (17) | | |
| | VISTAMAXX ™ | | |
| | 3980FL (50) | | |
| | POLYBATCH ™ F15 (8) | | |
| | POLYBATCH ™ CE | | |
| | 505E (8) | | |
| 17 | EXCEED ™ 3518CB | EXCEED ™ 3518CB | 1/3/1 |
| | (9.5) | (4) | |
| | ENABLE ™ 20-10CB | ENABLE ™ 20-10CB | |
| | (9.5) | (4) | |
| | VISTAMAXX ™ | VISTAMAXX ™ | |
| | 6102FL (30) | 6102FL (80) | |
| | VISTAMAXX ™ | VISTAMAXX ™ | |
| | 3980FL (35) | 3980FL (10) | |
| | POLYBATCH ™ F15 (8) | POLYBATCH ™ F15 | |
| | POLYBATCH ™ CE | (1) | |
| | 505E (8) | POLYBATCH ™ CE | |
| | | 505E (1) | |
| 18 | EXCEED ™ 3518CB | EXCEED ™ 3518CB | 1/3/1 |
| | (32) | (20) | |
| | ENABLE ™ 20-10CB | ENABLE ™ 20-10CB | |
| | (32) | (20) | |
| | VISTAMAXX ™ | VISTAMAXX ™ | |
| | 6102FL (20) | 6102FL (54) | |
| | CaCO₃ Master Batch (8) | CaCO₃ Master Batch | |
| | POLYBATCH ™ F15 (4) | (4) | |
| | POLYBATCH ™ CE | POLYBATCH ™ F15 | |
| | 505E (4) | (1) | |
| | | POLYBATCH ™ CE | |
| | | 505E (1) | |
| 19 | EXCEED ™ 3518CB | EXCEED ™ 3518CB | 1/3/1 |
| | (26.5) | (19) | |
| | ENABLE ™ 20-10CB | ENABLE ™ 20-10CB | |
| | (26.5) | (19) | |
| | VISTAMAXX ™ | VISTAMAXX ™ | |
| | 3980FL (35) | 6102FL (60) | |
| | POLYBATCH ™ F15 (8) | POLYBATCH ™ F15 | |
| | POLYBATCH ™ CE | (1) | |
| | 505E (4) | POLYBATCH ™ CE | |
| | | 505E (1) | |
| 20 | EXCEED ™ 3518CB | EXCEED ™ 3518CB | 1/3/1 |
| | (22.75) | (21.5) | |
| | ENABLE ™ 20-10CB | ENABLE ™ 20-10CB | |
| | (22.75) | (21.5) | |
| | VISTAMAXX ™ | VISTAMAXX ™ | |
| | 6102FL (18) | 6102FL (48) | |
| | VISTAMAXX ™ | VISTAMAXX ™ | |
| | 3980FL (24.5) | 3980FL (7) | |
| | POLYBATCH ™ F15 (8) | POLYBATCH ™ F15 | |
| | POLYBATCH ™ CE | (1) | |
| | 505E (4) | POLYBATCH ™ CE | |
| | | 505E (1) | |
| 21 | EXCEED ™ 3518CB | EXCEED ™ 3518CB | 1/3/1 |
| | (18.75) | (19.5) | |
| | ENABLE ™ 20-10CB | ENABLE ™ 20-10CB | |
| | (18.75) | (19.5) | |
| | VISTAMAXX ™ | VISTAMAXX ™ | |
| | 6102FL (18) | 6102FL (48) | |
| | VISTAMAXX ™ | VISTAMAXX ™ | |
| | 3980FL (24.5) | 3980FL (7) | |
| | CaCO₃ Master Batch (8) | CaCO₃ Master Batch | |
| | POLYBATCH ™ F15 (8) | (4) | |
| | POLYBATCH ™ CE | POLYBATCH ™ F15 | |
| | 505E (4) | (1) | |
| | | POLYBATCH ™ CE | |
| | | 505E (1) | |
| 22 | EXCEED ™ 3518CB | EXCEED ™ 3518CB | 1/3/1 |
| | (7.5) | (2) | |
| | ENABLE ™ 20-10CB | ENABLE ™ 20-10CB | |
| | (7.5) | (2) | |
| | VISTAMAXX ™ | VISTAMAXX ™ | |
| | 6102FL (30) | 6102FL(80) | |
| | VISTAMAXX ™ | VISTAMAXX ™ | |
| | 3980FL (35) | 3980FL (10) | |
| | CaCO₃ Master Batch (8) | CaCO₃ Master Batch | |
| | POLYBATCH ™ F15 (8) | (4) | |
| | POLYBATCH ™ CE | POLYBATCH ™ F15 | |
| | 505E (4) | (1) | |
| | | POLYBATCH ™ CE | |
| | | 505E (1) | |

### Example 3

Example 3 illustrates the effect of introducing a propylene-based elastomer into the core layer on mechanical properties, especially elasticity represented by hysteresis (%), of the film used for the inventive glove in comparison with the comparative PVC glove film. Samples 1-9 and 11-22 were selected for test of the properties below.

Hysteresis was measured according to the EMC method as previously defined.

Elmendorf tear strength was measured based on ASTM D1922-09 using the Tear Tester 83-11-01 from TMI Group of Companies and measures the energy required to continue a pre-cut tear in the test sample. Samples were cut across the web using the constant radius tear die and were free of any visible defects (e.g., die lines, gels, etc.). Samples were conditioned at a temperature of 23° C.±2° C. and a relative humidity of 50%±10% for at least 40 hours prior to the test.

Puncture resistance was measured based on ASTM D5748, which is designed to measure force and energy needed to puncture plastic film or sheeting, when subjected to a constant speed plunger plunging through it, provide load versus deformation response under biaxial deformation conditions at a constant relatively low test speed (change from 250 mm/min to 5 mm/min after reach pre-load (0.1N)). Film samples were tested below the cross-head area with the 2.5 kN load cell. The samples were about 550 mm*900 mm in size, and were conditioned for at least 40 hours at a temperature of 23±2° C. and a relative humidity of 50±10%. Maximum Puncture force is the maximum load achieved by the film sample before the break point, expressed in (N). Energy to break is the total energy absorbed by the film sample at the moment of break point, which is the integration of the area up to the breaking point under the load-deformation curve, expressed in (J).

Tensile properties of the glove films were measured by a method which is based on ASTM D882 with static weighing and a constant rate of grip separation using a Zwick 1445 tensile tester with a 200N. Since rectangular shaped test samples were used, no additional extensometer was used to measure extension. The nominal width of the tested film sample is 15 mm and the initial distance between the grips is 50 mm. The film samples were conditioned for at least 40 hours at a temperature of 23±2° C. and a relative humidity of 50+10%, and were measured in both machine direction (MD) and Transverse Direction (TD). Tensile strength at break is defined as the tensile stress at break point during the extension test, expressed in load per unit area (MPa).

Softness was measured by Handle-O-Meter test on a Thwing-Albert Handle-O-Meter Model 211-5 (Thwing-Albert Instrument Co., New Jersey, USA), which quantifies the resistance, expressed in grams, that a blade encounters when a material sample is forced into a slot of parallel edges. The quality of “hand” is considered to be the combination of resistance due to the surface friction and flexibility of the material. The slot width are provided with options including 5 mm, 10 mm, 20 mm, and ¼ inch, and is selected according to the test fabric softness. The samples were about 200 mm*200 mm in size and were tested both in both MD and TD.

Hermeticity was measured by detection of holes in polyethylene food service gloves according to ASTM D7246 on glove samples of 175 mm*165 mm in size, expressed by pass ratio (%).

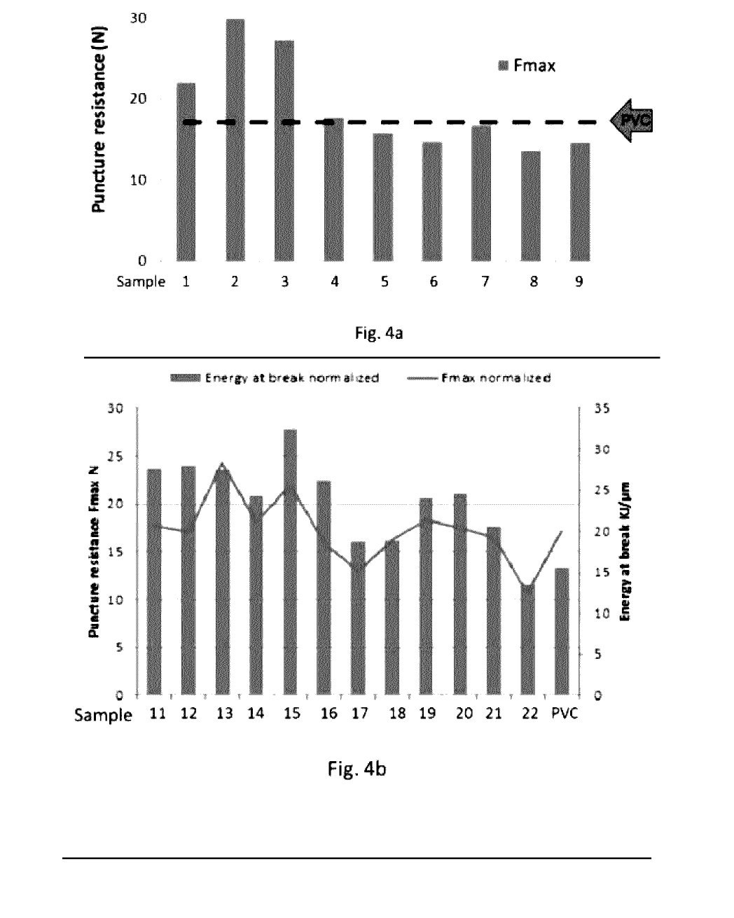

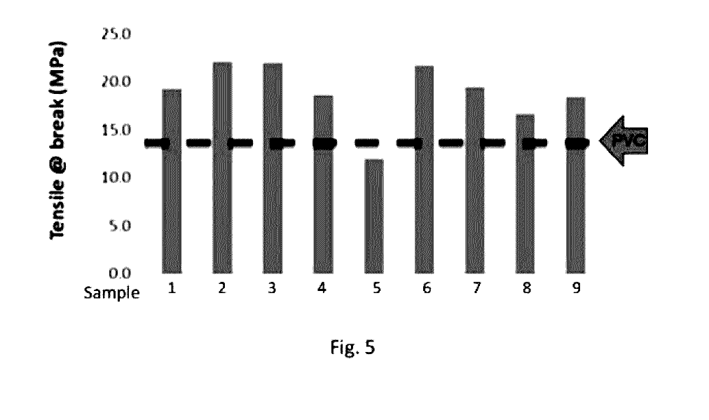

Test results for the above properties are successively depicted in FIG. 2-7.

As shown in FIG. 2, compared to the comparative PVC glove film. Samples 1-9 all showed improved elasticity, with a hysteresis of up to 10% lower than that of the comparative PVC glove film, which plays a key role in enhancing use comfort and fitting characteristic of the glove prepared therefrom. It can also be noted that films with outer layers made from mPE without the propylene-based elastomer performed better than those with outer layers comprising the propylene-based elastomer in this aspect.

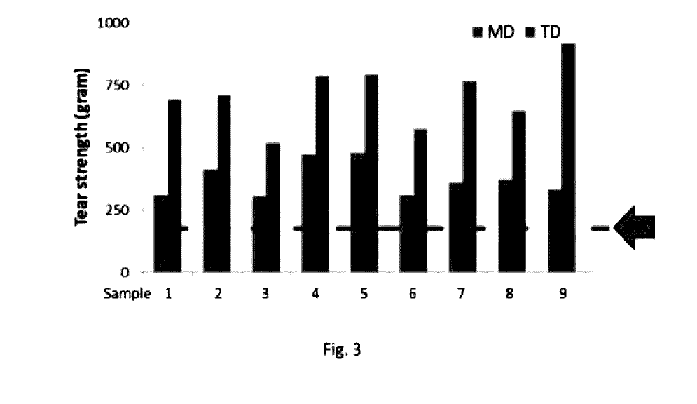

It can be seen from FIGS. 3-5 that rather than improving one property at the expense of compromising another, some other valuable mechanical properties of the film samples are also significantly improved along with the elasticity, including a tear strength in the Machine Direction (MD) of at least about 70% higher than that of a comparative PVC glove film and in the Transverse Direction (TD) of at least about 220% higher than that of a comparative PVC glove film (no MD/TD differentiation for dipped PVC gloves), a puncture resistance of up to about 75% higher than that of a comparative PVC glove film, and a tensile strength of at least about 15% higher than that of a comparative PVC glove film. Again, absence of the propylene-based elastomer from the outer layer made from mPE contributed to stronger puncture resistance and more consistent tensile strength.

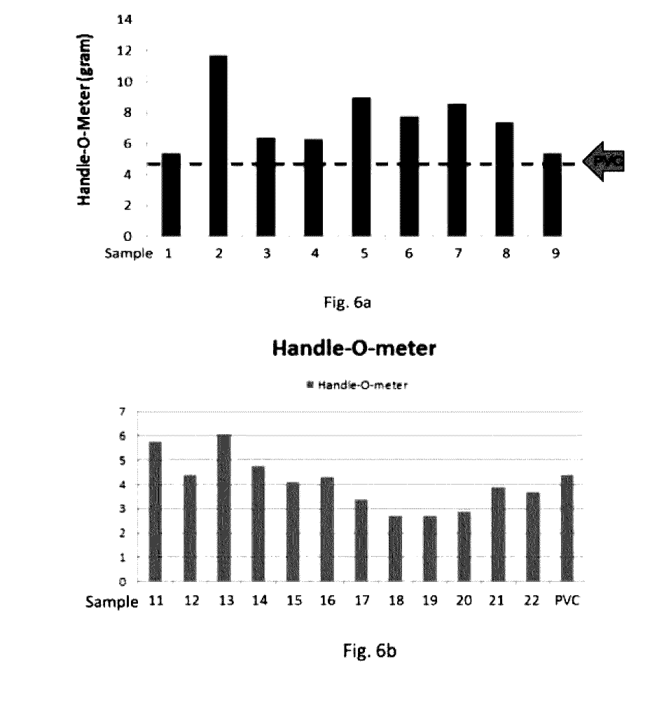

Although FIG. 6 demonstrates that some of the film samples used for the inventive glove suffered from loss to some extent in the softness compared to the comparative PVC glove film, it can still be expected that a comparable level of softness is likely to be maintained or fairly improved, as indicated by Samples 1, 3, 4, 9, and 17-22.

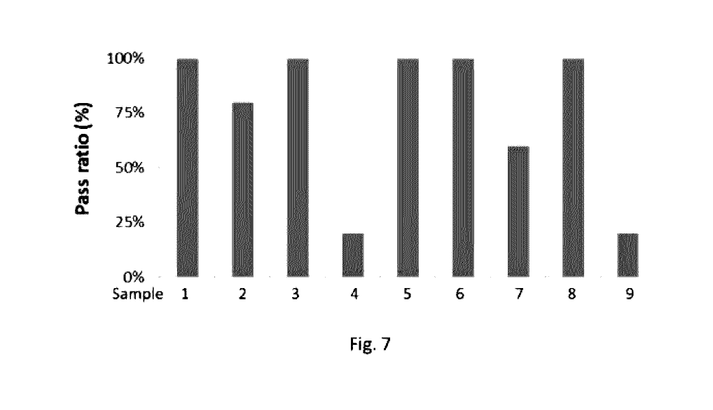

Results in FIG. 7 depict higher survival rate of the gloves made from samples with outer layers made from mPE without the propylene-based elastomer than that of the gloves made from samples with the propylene-based elastomer present in the outer layer in the detection of holes test, representing better seal strength and hermeticity performance of the former.

As a whole, introduction of the propylene-based elastomer into the core layer of a film as described herein can provide the glove prepared therefrom with desired use comfort and fitting characteristic while maintaining or even improving other mechanical properties, making the inventive glove qualified as a good alternative to the conventional PVC glove in various applications. Absence of the propylene-based elastomer in the outer layer can outperform presence of it in terms of some properties, however, the latter may be preferred to the former under specific circumstances where maximized recycle of the film layer is needed.

All documents described herein are incorporated by reference herein, including any priority documents and/or testing procedures. When numerical lower limits and numerical upper limits are listed herein, ranges from any lower limit to any upper limit are contemplated. As is apparent from the foregoing general description and the specific embodiments, while forms of the invention have been illustrated and described, various modifications can be made without departing from the spirit and scope of the invention. Accordingly, it is not intended that the invention be limited thereby.

What is claimed is:

1. A glove, comprising a film comprising a core layer, wherein the core layer comprises:
a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g.

2. The glove of claim 1, wherein the film has at least one of the following properties: (i) a hysteresis (EMC method) of up to 10% lower than that of a comparative PVC glove film; (ii) a tear strength in the Machine Direction (MD) of at least about 70% higher than that of a comparative PVC glove film and in the Transverse Direction (TD) of at least about 220% higher than that of a comparative PVC glove film: (iii) a puncture resistance of up to about 75% higher than that of a comparative PVC glove film; and (iv) a tensile strength of at least about 15% higher than that of a comparative PVC glove film.

3. The glove of claim 1, wherein the propylene-based elastomer is present in an amount of at least about 30 wt %, based on total weight of polymer in the core layer.

4. The glove of claim 1, wherein the propylene-based elastomer is present in an amount of about 100 wt %, based on total weight of polymer in the core layer.

5. The glove of claim 1, wherein the core layer further comprises a polyethylene.

6. The glove of claim 1, wherein the core layer further comprises at least one of a slip agent, an anti block, a filler, an antioxidant, an ultraviolet light stabilizer, a thermal stabilizer, a pigment, a processing aid, a crosslinking catalyst, a flame retardant, and a foaming agent.

7. The glove of claim 1, wherein the film further comprises an outer layer at each side of the core layer.

8. The glove of claim 7, wherein at least one outer layer comprises a polyethylene.

9. The glove of claim 8, where the outer layer comprises the polyethylene in amount of at least about 35 wt %, based on total weight of polymer in such outer layer.

10. The glove of claim 8, wherein at least one outer layer further comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g.

11. The glove of claim 8, wherein at least one outer layer further comprises at least one of a slip agent, an anti block, a filler, an antioxidant, an ultraviolet light stabilizer, a thermal stabilizer, a pigment, a processing aid, a crosslinking catalyst, a flame retardant, and a foaming agent.

12. The glove of claim 7, wherein the outer layers at each side of the core layers are identical.

13. The glove of claim 7, wherein the thickness ratio between one of the outer layers and the core layer is about 1:2 to about 1:9.

14. The glove of claim 1, wherein the film comprises three layers.

15. A glove, comprising a multilayer film comprising three layers, wherein the film comprises:
(a) two outer layers, each comprising a polyethylene present in amount of at least about 35 wt %, based on total weight of polymer in each such outer layer; and
(b) a core layer between the two outer layers, comprising a propylene-based elastomer present in an amount of at least about 30 wt %, based on total weight of polymer in the core layer, wherein the propylene-based elastomer comprises at least about 60 wt % propylene-derived units and about 3 to about 25 wt % ethylene-derived units, based on the total weight of the propylene-based elastomer, wherein the propylene-based elastomer has a heat of fusion of less than about 80 J/g;
wherein the two outer layers are identical, and the thickness ratio between each outer layer and the core layer is about 1:3 to about 1:5.

16. The glove of claim 15, wherein each of the two outer layers further comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g.

17. The glove of claim 15, wherein the core layer further comprises a polyethylene.

18. A method for making a glove, comprising the steps of:
(a) preparing a film comprising a core layer, wherein the core layer comprises a propylene-based elastomer comprising at least about 60 wt % propylene-derived units and about 3 to about 25 wt % ethylene-derived units, based on the total weight of the propylene-based elastomer, wherein the propylene-based elastomer has a heat of fusion of less than about 80 J/g; and
(b) forming a glove comprising the film in step (a).

19. The method of claim 18, wherein the film in step (a) further comprises an outer layer at each side of the core layer.

20. The method of claim 19, wherein at least one outer layer comprises a polyethylene.

21. The method of claim 18, wherein the film in step (a) is prepared by blown extrusion, cast extrusion, coextrusion, blow molding, casting, or extrusion blow molding.

22. The method of claim 18, wherein the layer surface of the film designed to be the inner surface of the glove is embossed.

23. The method of claim 18, wherein the glove in step (b) is formed by stamping, blown molding, or shrink molding.
